(19) United States
(12) Patent Application Publication
(10) Pub. No.: US 2025/0151022 A1
(43) Pub. Date: May 8, 2025

(54) METHOD AND APPARATUS FOR SIDELINK POSITIONING

(71) Applicant: Nokia Technologies Oy, Espoo (FI)

(72) Inventors: Oana-Elena BARBU, Aalborg (DK); Ping-Heng KUO, Cambridge (GB); Diomidis MICHALOPOULOS, Munich (DE)

(21) Appl. No.: 18/834,132

(22) PCT Filed: Jan. 17, 2023
(86) PCT No.: PCT/EP2023/050960

§ 371 Date: Jul. 29, 2024

(30) Foreign Application Priority Data
Feb. 8, 2022 (FI) 20225106

(51) Int. Cl. H04W 64/00; G01S 5/02; H04W 52/36

(52) U.S. Cl. CPC H04W 64/003; G01S 5/0236; H04W 52/365

(57) ABSTRACT

Positioning in a first terminal device that performs receiving from a coordination entity an anchor feared event request for sidelink positioning of a target device; and transmitting an anchor feared event response that indicates an integrity of the first terminal device candidate as a positioning anchor device for the target device. The anchor feared event response includes at least one of following feared event indicators: a link quality characteristic of a channel between the first terminal device and the target device; or power headroom of the first terminal device. A corresponding method in the coordinating entity, and computer program, apparatus, and non-transitory computer readable medium are also disclosed.

### TECHNICAL FIELD

Various example embodiments relate to method and apparatus for sidelink positioning, particularly related to integrity constrained sidelink configuration for sidelink positioning.

### BACKGROUND

This section illustrates useful background information without admission of any technique described herein representative of the state of the art.

Modern terminal devices are often capable of positioning using satellite signals, sometimes with FM transmission-based enhancement. Moreover, there are implementations that employ Bluetooth or Wireless LAN transmitters of known locations for positioning, as well as base station triangulation-based implementations.

In modern mobile communications, user equipment may communicate with each other using sidelinks. The sidelinks can be used to exchange data between various machine type devices and in a host of applications, including sharing data for positioning. Sidelink positioning can be used to aid, supplement, or substitute potentially missing satellite or base station signals used for positioning.

However, it is apparent that terminal devices are generally unreliable beacons in terms of their position, reliability of the position known by them, as well as sidelink connectivity with surrounding terminal devices. The integrity of sidelink positioning should be ensured. In the context of this disclosure, integrity refers to a measure of the trust in the accuracy of the position-related data and the ability to provide associated warning messages, rather than mitigation or detection of malicious altering of transmissions.

The integrity can be compromised by various issues relating to a sidelink positioning anchor, here referred to as feared events, or anchor feared events. While such feared events could be collected from all terminal devices in a mobile communication network periodically and pre-emptively, such data collection and related processing would result in an unbearable cost in radio resource and computation.

It is desirable to facilitate a sidelink positioning target device to acquire and account for integrity issues of any of anchor devices used by the target device in the positioning. It is also desirable to curb the costs in radio resource and processing resource use.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first example aspect of the present invention, there is provided a method in a first terminal device for sidelink positioning, comprising
receiving from a coordination entity an anchor feared event request for positioning of a target device; and
transmitting an anchor feared event response that indicates at least one factor affecting a positioning integrity of the target device with the first terminal device acting as an anchor.

The coordination entity may be a location server. The coordination entity may be a location management function. The coordination entity may reside on a network side. Alternatively, or additionally, the coordination entity may by implemented by the target device. The coordination entity may by implemented by the target device, e.g., if the target device is out of network coverage. The coordination entity may by implemented by a terminal device that has currently no role as a target device or as an anchor device or anchor device candidate. The coordination entity may by implemented by the first terminal device. Alternatively, the coordination entity may be a next generation node B, gNB.

According to a second example aspect of the present invention, there is provided a method in a first terminal device for sidelink positioning. The first terminal device may operate during a first period as a target device. The first terminal device may operate during a second period as an anchor candidate device or as an anchor device selected for one or more target devices. The first period and the second period may be overlapping. The first period and the second period may be distinct.

The first terminal device may operate during a third period in an idle mode in which the first terminal device is operating as one of: the target device; an anchor device candidate; or an anchor device selected for a one or more target devices.

The first terminal device may obtain an anchor feared event request. The first terminal device may obtain the anchor feared event request when operating as the target device. The first terminal device may obtain the anchor feared event request when operating as the anchor device candidate. The first terminal device may obtain the anchor feared event request when operating as the anchor device selected for one or more target devices.

The first terminal device may provide the coordination entity with an anchor feared event response indicative of an integrity of the first terminal device as a sidelink positioning anchor device. The providing of the anchor feared event response may be subjected to one or more response conditions. The one or more response conditions may include having a battery status satisfying a battery threshold. The one or more response conditions may include a user set permission to operate as the anchor device. The one or more response conditions may include absence of conflicting other operations of the first terminal device.

The first terminal device may provide the coordination entity with an anchor feared event response reject message if the first terminal device refuses to operate as the anchor device candidate.

The first terminal device may further perform a target device based sidelink positioning. In the target device based sidelink positioning, the first terminal device may receive sidelink positioning assistance information comprising at least a subset of the assistance data; and/or of the feared event indicators. The target device may compute its own positioning integrity using the received sidelink positioning assistance information.

The first terminal device may initiate a sidelink positioning assistance process by providing the coordination entity with a sidelink positioning assistance request.

The anchor feared event response may comprise at least one of following feared event indicators:
a) a link quality characteristic of a channel between the first terminal device and the target device;
b) a parameter relating to at least one factor causing sidelink positioning error;
c) an integrity result of a positioning estimate of the first terminal device.
d) power headroom of the first terminal device
e) user equipment type, such as a handheld device, vehicle mounted device, and/or machine type device;
f) interference in candidate sidelink resources as determined in result of sidelink sensing operations;
g) power or battery status;
h) mobility level;
i) radio resource control mode.

The anchor feared event response may comprise the feared event indicators d) to j). The anchor feared event response may comprise the feared event indicators a) to d). The anchor feared event response may comprise the feared event indicators a) and c).

In an example embodiment, the first terminal device performs:
obtaining from the coordination entity an anchor feared event request for sidelink positioning of a target device;
forming an anchor feared event response indicative of an integrity of the first terminal device as a sidelink positioning anchor device so that the anchor feared event response comprises at least one of the feared event indicators a) to d) or d) to j).

The first terminal device operating as the sidelink positioning anchor device may perform establishing a sidelink positioning session with the target device. The sidelink positioning session may be established on request of the target device. Alternatively, sidelink positioning session may be established on request of the coordination entity.

The method may further comprise obtaining assistance data derived from the anchor feared event responses of one or more second terminal devices acting as anchor device candidates. Same first terminal device may operate at different times or concurrently as a target device for a one positioning session and as an anchor device candidate or anchor device for another positioning session. The first positioning session may be initialized before the second positioning session. The first positioning session may be initialized after the second positioning session. The first positioning session may be initialized together with the second positioning session for improving the integrity of the first terminal device as an anchor device for sidelink positioning of the target device.

A terminal device may refer to a device capable of mobile communications. A terminal device may refer to a device capable of cellular communications. A terminal device may refer to a device capable of 4G or 5G cellular communications.

According to a third example aspect of the present invention, there is provided a method in a coordination entity for sidelink positioning, comprising
transmitting to one or more first terminal devices an anchor feared event request for sidelink positioning of a target device;
receiving from at least a subset of the one or more first terminal devices an anchor feared event response, wherein the anchor feared event response indicates an integrity of the first terminal device as a positioning anchor device for the target device.

The positioning may be sidelink positioning.

The method may further comprise deriving assistance data for the target device based on the received anchor feared event responses.

The assistance data may estimate a probability of sidelink positioning failures of the anchor device candidates based on the received anchor feared event responses.

The method may further comprise providing the target device with the assistance data concerning at least some or all the candidate anchor devices.

The method may further comprise selecting one or more anchor devices for the target device based on the assistance data or the anchor feared event response. The target device may be provided with information about the selected one or more anchor devices. The information about the selected one or more anchor devices may identify the selected one or more anchor devices. Alternatively, or additionally, the information about the selected one or more anchor devices may comprise the assistance data for the selected one or more anchor devices.

The anchor feared event may comprise at least two of the feared event indicators a) to j) The anchor feared event may comprise the feared event indicators a) and d) for, for example, mitigating integrity risks caused by radio conditions. The anchor feared event may comprise the feared event indicators f) and h), for, for example, further accounting for positioning integrity risks caused by factors potentially prejudicing the integrity of the anchor device candidate. The anchor feared event request may indicate a compulsory response, for example, in case of an emergency positioning request issued by or for the target device.

The anchor feared event response may further comprise one or more of further feared event indicators. The further feared event indicators may comprise a traffic type of the candidate anchor device; for example, sidelink positioning reference signal may be de-prioritized by a physical uplink shared channel and thus not be transmitted. The further feared event indicators may comprise a load of the candidate anchor device. The further feared event indicators may comprise a sidelink load of the candidate anchor device, wherein the sidelink load may include a number, type, and/or duration of sidelink sessions across distinct sidelink resources the anchor device candidate is already committed to or has accepted to be committed to. The further feared event indicators may comprise a likelihood of a listen-before-talk failure of the candidate anchor device, e.g., when operating in an unlicensed band or in a shared frequency band without a centralized scheduling.

The method may further comprise receiving a sidelink positioning assistance request for a sidelink positioning session. The method may further comprise responsively initiating a selection of one or more anchor devices for the target device.

The method may further comprise obtaining an anchor integrity value for the first positioning session based on a duration of an anchor device candidate availability.

The estimating of the probability of sidelink positioning failure may comprise computing an anchor integrity value. The computing of the anchor integrity value may use feature scaling to compute the anchor integrity value based on different feared event indicators and/or integrity requirements (also known as integrity KPIs) such as target integrity risk, TIR, and alert limit, AL. Alternatively, the estimating of the probability of sidelink positioning failure may comprise determining an anchor integrity value using one or more lookup tables. The anchor integrity value may be represented by a protection level, PL, value, or a binary value indicating whether the anchor device fulfils the integrity requirement.

The interference levels may be determined for a candidate sidelink communication resource pool. The candidate sidelink communication resource pool may be defined the coordination entity when the coordination entity resides at the network side. The candidate sidelink communication resource pool may be shared with the sidelink communication resource pool when no network support is available.

The mobility level may be based on a beam misalignment of a sidelink positioning reference signal. Alternatively, or additionally, the mobility level may be based on a last known velocity.

The radio resource control mode may be connected. The radio resource control mode may be idle. The radio resource control mode may be inactive.

The one or more anchor device candidates may be selected by the coordination entity out of a plurality of terminal devices. Alternatively, or additionally, the coordination entity may receive a portion of or the entire selection of the one or more anchor device candidates from the target device.

The plurality of terminal devices may reside within a given area of interest. The area of interest may be smaller or equal to a target device sidelink coverage area multiplied by a first factor f1. The first factor f1 may be less than 2; 5; 10; or 20.

The anchor devices may be chosen based on the integrity results and the proximity to the target device, the latter being derived using information about the target's coarse location information such as serving beam index, TA, etc. The location management function may reject one or more candidate anchor devices if the candidate anchor devices have been anchors devices in the past X seconds and or their sessions have been associated with low SL positioning accuracy. X may be at least 60; 120; 300; 600; 1800; 3600; or 7200. X may be at most 120; 300; 600; 1800; 3600; 7200; or 86400.

The method may further comprise establishing a sidelink positioning session between the target device and a selected anchor device. Parallel sidelink positioning sessions may be established when the target device is assisted by two or more anchor positioning devices. The establishing of the sidelink positioning session may be initiated by the coordination entity. The establishing of the sidelink positioning session may be initiated by the target device.

The target device may be a 5G enabled terminal device. The candidate anchor devices device may be a 5G enabled terminal devices. The terminal devices may be capable of communicating with other terminal devices. The terminal devices may operate with a shared uplink and downlink band. The terminal devices may use code division multiple access. The terminal devices may use time division multiple access. The terminal devices may use orthogonal frequency division multiple access.

According to a fourth example aspect of the present invention, there is provided a first terminal device comprising means for performing the method of the first or second example aspect.

According to a fifth example aspect of the present invention, there is provided a coordination entity comprising means for performing the method of the third example aspect.

According to a sixth example aspect of the present invention, there is provided an apparatus comprising at least one transmitter, configured to at least cause performing the method of the first, second, or third example aspect. The apparatus may further comprise at least one processor configured to control the transmitter. The apparatus may further comprise at least one memory storing instructions for the processor.

According to a seventh example aspect of the present invention, there is provided a computer program comprising computer program code which, when executed, causes an apparatus to at least perform the method of the first, second, or third example aspect.

The computer program may be stored in a computer readable memory medium. The memory medium may comprise a digital data storage such as a data disc or diskette, optical storage, magnetic storage, holographic storage, opto-magnetic storage, phase-change memory, resistive random-access memory, magnetic random-access memory, solid-electrolyte memory, ferroelectric random-access memory, organic memory, or polymer memory. The memory medium may be formed into a device without other substantial functions than storing memory or it may be formed as part of a device with other functions, including but not limited to a memory of a computer, a chip set, and a sub assembly of an electronic device.

According to an eighth example aspect of the present invention, there is provided a system comprising the coordination entity of any example aspect, and the first terminal device or the target device of any example aspect.

Any foregoing memory medium may comprise a digital data storage such as a data disc or diskette, optical storage, magnetic storage, holographic storage, opto-magnetic storage, phase-change memory, resistive random-access memory, magnetic random-access memory, solid-electrolyte memory, ferroelectric random-access memory, organic memory, or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a schematic drawing of sidelink transmissions of an example embodiment;

FIG. 2 shows an architectural drawing of a sidelink positioning system of an example embodiment;

FIG. 3 shows a signaling chart of a method of an example embodiment;

FIG. 4 shows a signaling chart of a method of an example embodiment for positioning integrity handling;

FIG. 5 shows a signaling chart of a method of an example embodiment for selecting anchor devices;

FIG. 6 illustrates integrity checks of vs periodicity of the session, according to an example embodiment;

FIG. 7 shows a signaling chart of a method of an example embodiment for selecting anchor devices;

FIG. 8 shows flow chart of a method in a terminal device for sidelink positioning, according to an example embodiment;

FIG. 9 shows flow chart of a method in a coordination entity for mobile sidelink positioning of an example embodiment;

FIG. 10 shows a flow chart of a method in the coordination entity for sidelink positioning of an example embodiment;

FIG. 11 shows a collection of optional further features combinable with the in the coordination entity for mobile sidelink positioning of an example embodiment; and

FIG. 12 shows a block diagram of an apparatus of an example embodiment.

### DETAILED DESCRIPTION OF THE DRAWINGS

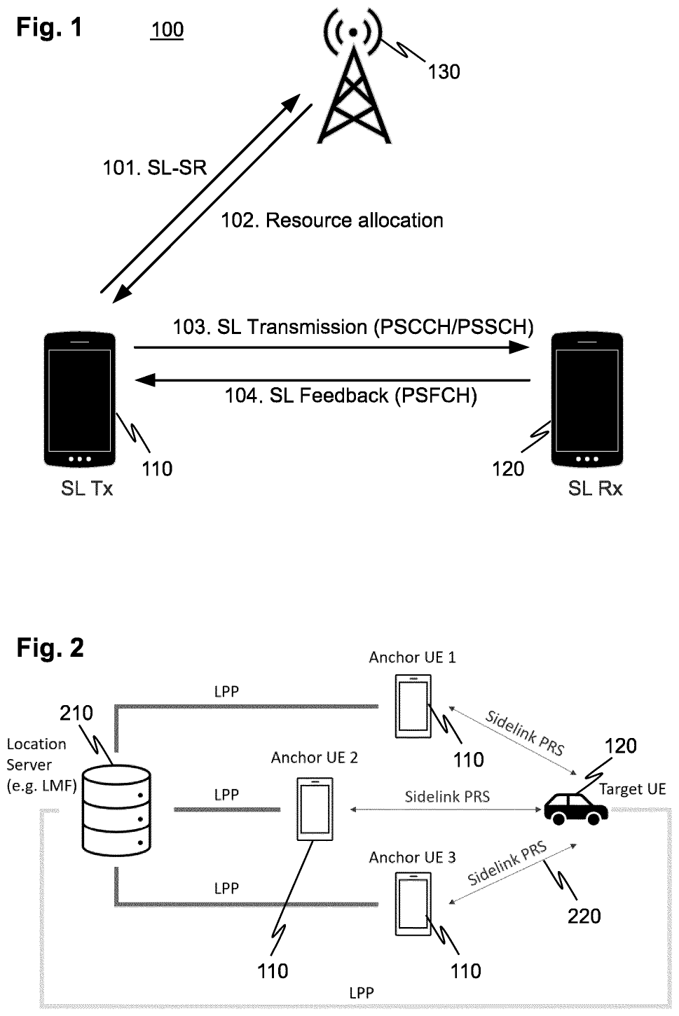

An example embodiment of the present invention and its potential advantages are understood by referring to FIGS. 1 through 12 of the drawings. In this disclosure, like reference signs denote like parts or steps.

FIG. 1 shows a schematic drawing of sidelink transmissions of an example embodiment.

A new radio, NR, sidelink, SL, facilitates a user equipment, UE, to communicate with other nearby UE(s) via direct/SL communication. Two resource allocation modes have been specified in 3GPP release 16, and a SL transmitter, Tx, UE is configured with one of them to perform its NR SL transmissions. These modes are denoted as NR SL mode 1 and NR SL mode 2. In mode 1, a sidelink transmission resource is assigned by the network, NW, to the SL Tx UE, while a SL Tx UE in mode 2 autonomously selects its SL transmission resources. The following embodiments relate to mode 1 in which the network schedules radio resources.

In mode 1, where a 5G NB, gNB, is responsible for the SL resource allocation, the configuration and operation is similar to the one over the Uu interface depicted in FIG. 1.

Sidelink positioning is under development. With sidelink positioning, a positioning reference signal, PRS, is transmitted in the sidelink to facilitate positioning of a target UE. In particular, the target UE could measure the PRS transmitted by one or more anchor UEs and calculate its own position with its knowledge about the locations of these anchor UEs. Alternatively, the target UE could report the measurement of the sidelink PRS to the network, and a location server (e.g., a location management function, LMF) could perform the position estimation of the target UE. Notice that the LMF may also reside in some example embodiments at the target UE itself.

To enable the positioning procedure by means of LMF, the network should have connections to potential anchor UEs, so it may select an appropriate set of anchor UEs to serve the target UE based on certain criteria. We will consider following two scenarios:

Scenario 1: The target UE is within network coverage, so the location server is also connected to the target UE.

Scenario 2: The target UE is out of the network coverage, so the location server may not have a (direct) connection to the target UE. A connection may be established, though, through a sidelink, but such a connection may not reside with a sufficient reliability.

FIG. 2 shows an architectural drawing of a sidelink positioning system of an example embodiment, where an LTE positioning protocol, LPP, interface between the location server and the target UE is present or absent, depending on that whether the target UE 120 is within the network coverage.

The positioning integrity basically refers to a measure of trust of position estimate of a device. If a device fails to meet the required integrity performance, then a related position estimation cannot be trusted by an entity or client that was going to use the positioning information. In an integrity context, what is trusted is that gross errors, i.e., errors far greater than an accuracy target, are avoidable. To quantify the position integrity, several metrics or here feared event indicators are defined, among which:
1. an integrity risk, IR, refers to a probability that the system generates an error without providing a timely warning about such potential error.
2. An alert limit, AL, refers to a magnitude of error that, once exceeded is unacceptable, safety-wise, which alert limit may be application dependent and expressed with, e.g., protection levels or limits, such as vertical or horizontal protection levels or limits.
3. time to alert, TTA, refers to a time between the occurrence of the error, e.g., when an alert limit is violated, and the time when the alert or correction is issued to ensure protection against the underlying problem.

In some cases, the positioning integrity for a global navigation satellite system, GNSS, is supported, wherein the NW or the device may obtain information relating to integrity performance required by an application or by a location services, LCS, client, from the location server. And, based on this information and GNSS measurements, the device derives and reports its integrity performance metric, such as a protection level, to the location server. Thus, the network (and the LCS client) can know if the position estimate of this device is worth trusting.

Some of the following example embodiments may devise a procedure that allows the target UE to acquire and account for the supporting UE uncertainty in a sidelink integrity framework. In the following, some example embodiments are described using terms target device and anchor device, intending to refer to a device that comprises the UE and may further comprise other equipment, such as a host device, such as further hardware and software of a machine type device.

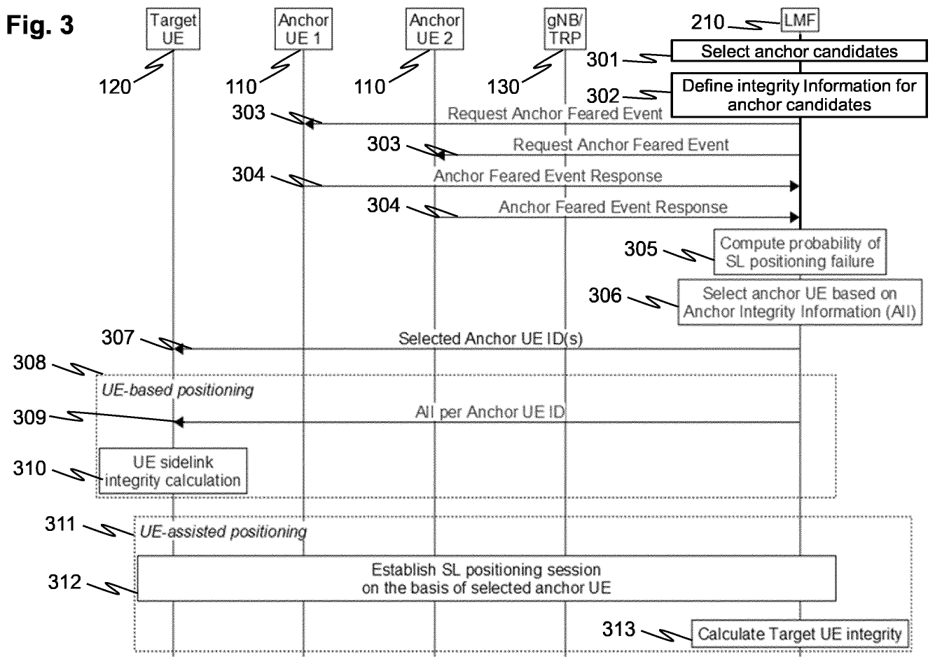

FIG. 3 shows a signaling chart of a method of an example embodiment, wherein an integrity support framework is extended to a NR SL operation.

While the LMF has been depicted as a separate entity, however, it may reside at the NW side, or at the target device side, when the target device is out of network coverage:
1. When the target device is in coverage, the LMF coordinates the anchors AFE collection via integrity messages sent over LPP interface.
2. When the target device is out of coverage, a local LMF functionality is triggered, and the target device broadcasts over SL a positioning request. In this request, (or in a subsequent SL message sent after other SL devices have responded to the request) the target device may append the AFE request. Then, the anchor devices respond with the AFE via either:
   i. a SL unicast/multicast message towards the target(s) or
   ii. a SL broadcast, so that other potential targets may consider the device as a potential anchor device.

In an example embodiment, the LMF performs one or more of:
301: Selecting anchor device candidates
302: Defining integrity information of a candidate anchor UE, which integrity information may be referred to as an anchor-UE feared event or anchor device feared event, AFE.
303: Requesting candidate anchors devices to compute and reporting their AFE.
304: Receiving AFE from all required candidate anchor devices
305: deriving assistance data for the candidate target devices using the received AFE
306: selecting anchor devices using the assistance data in view of integrity of the target device.
307: Providing the target device with the selected anchor device identity or identities; or
308: In a target device-based integrity, the derived assistance data is provided to the target device so that the target device can determine its own sidelink integrity result. Here, following steps may be taken:
309: the LMF provides the target device with the derived assistance data of the candidate anchor devices.
310: The target device performs UE sidelink integrity calculation, accounting for:
   i. its own position measurement uncertainties e.g., due to mobility, accuracy and latency of measurement acquisition, measurement errors due to own processing imperfections (frequency and time offsets).
   ii. position uncertainties of each anchor devices.
311: In device assisted positioning, the LMF uses the AFE not only to select the anchor device(s), but also for:
312: establishing the SL session(s) based on the selected anchor(s) and, after collection of SL-positioning measurements, for
313: computing the target UE location and its integrity.

Note that an anchor device, prior to replying with AFE response, may temporarily become a target device and refresh its position estimate, followed by a refresh of its AFE. In other words, an anchor device may trigger its own SL positioning, including the procedure from FIG. 3 in response to the AFE request.

The AFE may comprise binary and/or non-binary feared event indicators that an anchor device should report to the LMF upon request.

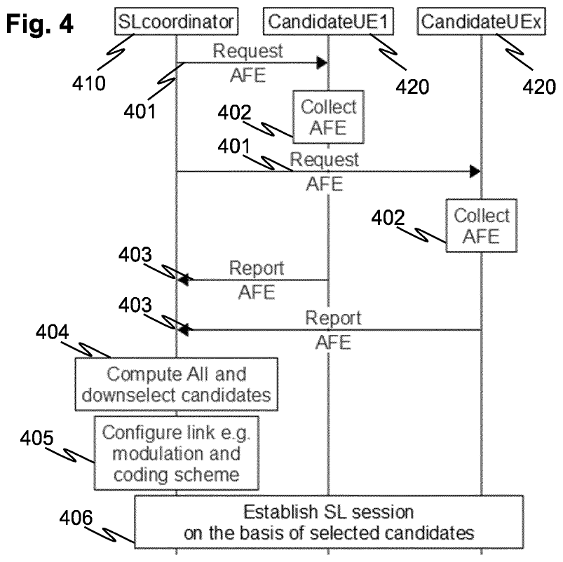

FIG. 4 shows a signaling chart of an example embodiment for positioning integrity handling. FIG. 4 summarizes the integrity framework for SL communication scenario where a coordination entity 410 (e.g., gNB for the NR SL mode 1 or the target device for the NR SL mode 2) selects one or more candidate anchor devices 420 for the SL data transfer (e.g., relaying devices). This example embodiment comprises one or more of:
401: A coordination entity transmits the AFE request to each candidate anchor device.
402: The candidate anchor devices collect AFE.
403: The candidate anchor devices provide the SL coordinator with their AFE reports.
404: The SL coordinator computes derived assistance data based on the AFE reports and down-selects anchor device candidates or selects the anchor devices for the target device.
405: The SL coordinator configures necessary link(s), e.g., defines their modulation and/or coding schemes.
406: The selected anchor device candidates establish SL session(s) with the target device.

Prior to the method illustrated by FIG. 4, in an example embodiment, down-selecting of candidate anchor devices is performed in advance to determine the candidate anchor devices to which the AFE requests should be sent.

To support sidelink operation (communication and/or positioning) at a target device, the coordination entity facilitates in determining suitable positioning resources, e.g., anchor devices, which should be applied. In particular, the positioning performance of the candidate anchor devices should be taken into account on selecting (candidate) target devices.

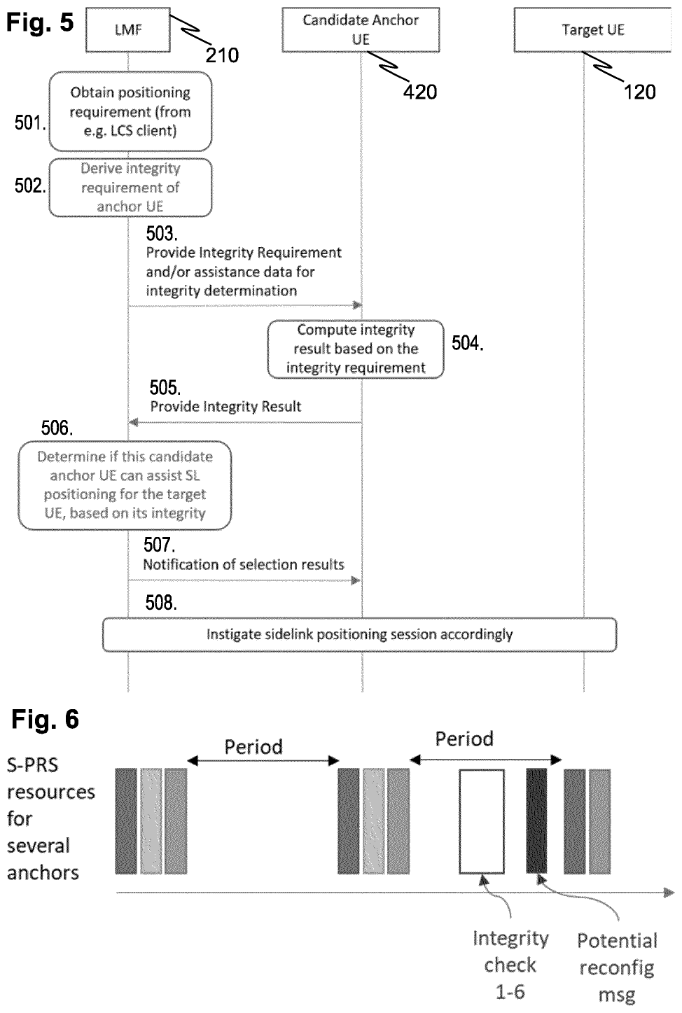

FIG. 5 shows a signaling chart of a method of an example embodiment for selecting candidate anchor devices, by a gNB or LMF (suitable for in coverage scenario). The method comprises one or more of:
501: The SL coordinator obtains a positioning requirement (e.g., accuracy and/or integrity and/or latency) of the target device.
502: Based on SL quality of service, QoS, requirements, the SL coordinator derives the integrity requirement (e.g., target integrity risk—TIR; alert limit—AL) that the anchor devices should satisfy in order to meet the QoS requirements of the target device.
503: The SL coordinator provides the derived positioning integrity requirement to at least one candidate anchor device.
504: The SL coordinator provides the candidate device with assistance data to enable the candidate device to estimate its own integrity (e.g., synchronicity uncertainties for time-based positioning methods; angular calibration uncertainties for angular-based methods; and/or satellite error probability for GNSS positioning).
505: Each candidate anchor device derives its own integrity result based on the positioning integrity requirement and provides same to the SL coordinator.
506: The SL coordinator receives the derived integrity result(s) from at least one of the candidate anchor devices.
507: The SL coordinator determines which one(s) of the candidate anchor devices should be selected to assist SL positioning of the target device.
508: The SL coordinator notifies the selected anchor devices.
509: The SL session is instigated based on the selected anchor devices.

FIG. 6 illustrates integrity checks of vs periodicity of the session, according to an example embodiment.

In case the SL session has a periodic character, e.g., if the position of the target device needs refreshing with a given frequency, integrity checks may be periodically performed. In an example embodiment, integrity checks 1-6 need to be performed periodically as well, after which the session may need reconfiguration. The refresh rate of the checks 1-6 need not equal to that of the target device position refresh rate and may depend on the type and availability of the anchor device.

Conversely, if the SL session cannot be set up with a given periodicity, sub-sessions can be configured, and integrity checks 1-6 be performed after one or more of such sub-sessions are finalized.

FIG. 7 shows a signaling chart of an example embodiment for selecting anchor devices by the target device (suitable for out of coverage scenario)

In an example embodiment, to support sidelink operation of a target device that is out of the coverage, the target device determines by itself suitable positioning resources (e.g., anchor devices selection, SL-PRS transmission, and/or subsequent measurement collection) that should be applied. In particular, the integrity performance of the candidate devices (relays/anchors) may be taken into account. FIG. 7 shows:
701: The target device may obtain QoS requirement (e.g., accuracy, integrity, and/or latency) from a location services, LCS, client, for example.
702: The target device may derive the positioning integrity requirement (e.g., TIR, AL) that the anchor devices should satisfy in order to meet the SL requirements of the target device
703: The target device provides the derived integrity requirement to at least one candidate anchor device, e.g., via SL unicast or SL broadcast signaling.
704: Each candidate anchor device derives its own integrity result based on the derived integrity requirement and provides same to the target device. This can be provided, e.g., via SL unicast or SL broadcast signal. The benefit of the latter approach is that the report may be received and used by another device as a new target device for configuring its own positioning session.
705: The target device receives integrity results of at least one candidate anchor device.
706: The target device may determine which one or ones of the candidate anchor devices will be selected to assist SL positioning for the target device.
707: The target device may notify at least one selected anchor device about the selection result.
708: The selected anchor device may notify network (gNB and/or LMF) that it has been selected by the target device for sidelink positioning.

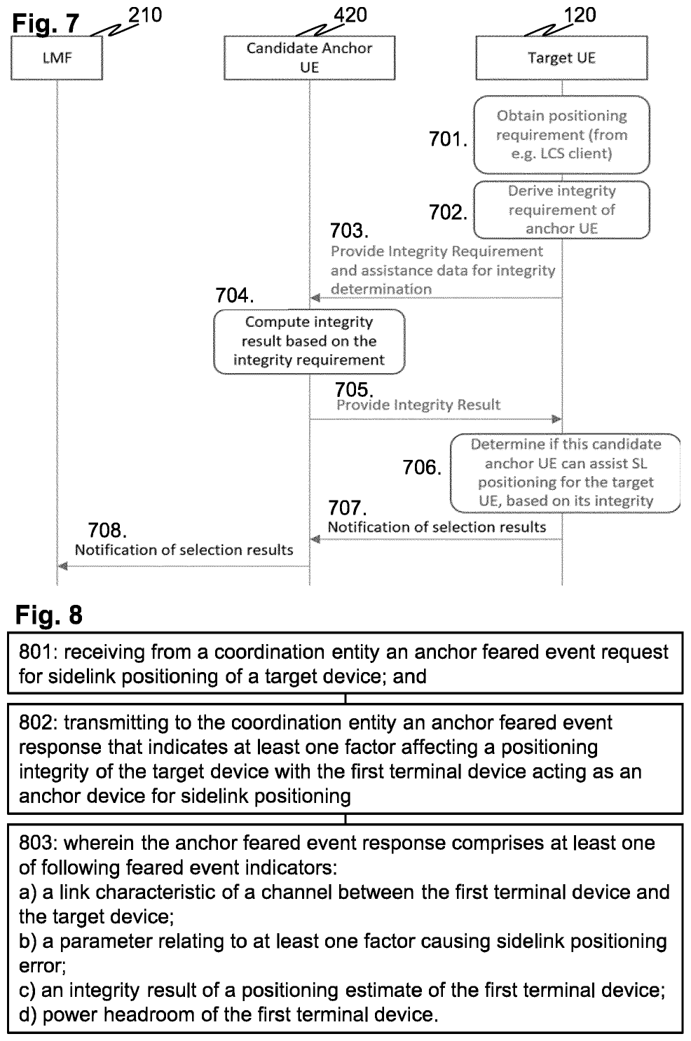

FIG. 8 shows a flow chart of a method in a first terminal device for sidelink positioning, according to an example embodiment; comprising any one or more of:
801: receiving from a coordination entity an anchor feared event request for sidelink positioning of a target device; and
802: transmitting to the coordination entity an anchor feared event response that indicates at least one factor affecting a positioning integrity of the target device with the first terminal device acting as an anchor device for sidelink positioning;
803: wherein the anchor feared event response comprises at least one of following feared event indicators:
   a) a link quality characteristic of a channel between the first terminal device and the target device;
   b) a parameter relating to at least one factor causing sidelink positioning error;
   c) an integrity result of a positioning estimate of the first terminal device;
   d) power headroom of the first terminal device.

FIG. 9 shows a flow chart of a method in the coordination entity for mobile sidelink positioning of an example embodiment; comprising any one or more of:
901: transmitting to one or more first terminal devices an anchor feared event request for sidelink positioning of a target device;
902: receiving from at least a subset of the one or more first terminal devices an anchor feared event response, wherein the anchor feared event response indicates at least one factor affecting a positioning integrity of the target with the first terminal device acting as an anchor device for sidelink positioning;
903: wherein the anchor feared event response comprises at least one of following feared event indicators:
   a) a link quality characteristic of a channel between the first terminal device and the target device;
   b) a parameter relating to at least one factor causing sidelink positioning error;
   c) an integrity result of a positioning estimate of the first terminal device;
   d) power headroom of the first terminal device.

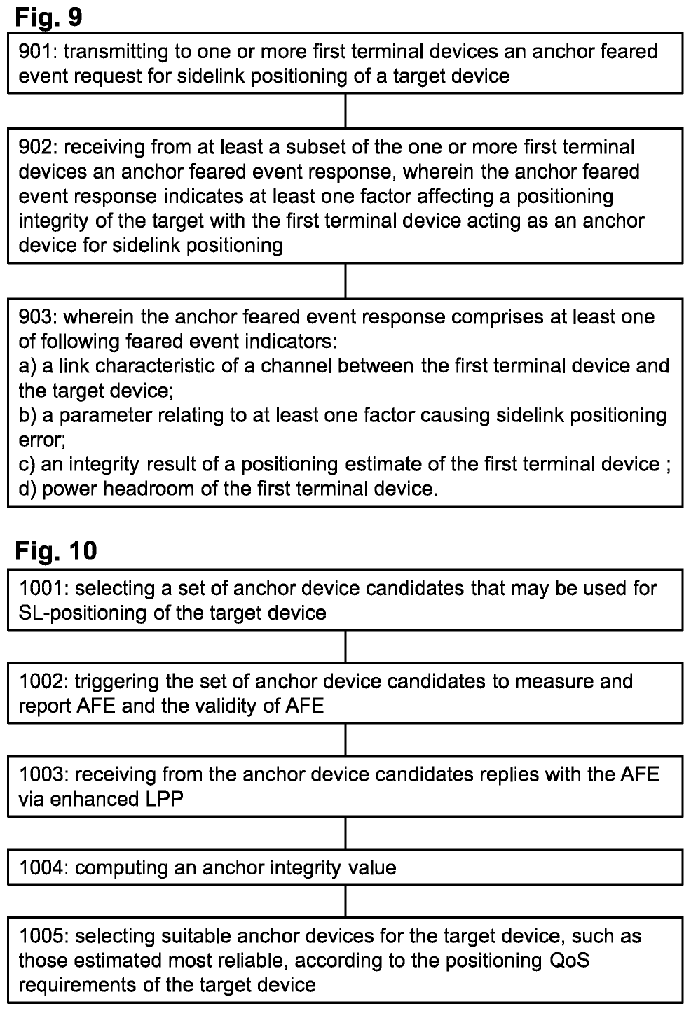

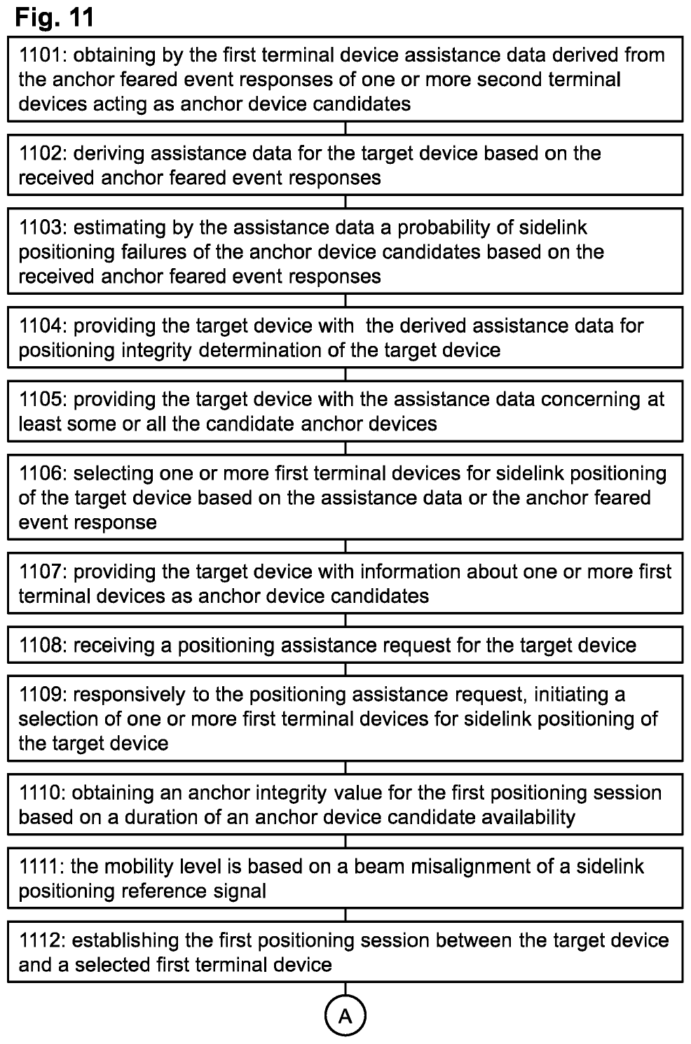

FIG. 10 shows a flow chart of a method in the coordination entity for sidelink positioning of an example embodiment; comprising any one or more of:
1001: selecting a set of anchor device candidates that may be used for SL-positioning of the target device;
1002: triggering the set of anchor device candidates to measure and report AFE and the validity of AFE, e.g., the time duration for which AFE is expected not to change;
1003: receiving from the anchor device candidates replies with the AFE via enhanced LPP, wherein no reply may be received from such an anchor device candidate that rejects the request in case of being unavailable, e.g., due to ongoing operations;
1004: computing an anchor integrity value, e.g., probability of SL positioning failure per anchor, PPF, and/or duration of anchors availability; and
1005: selecting suitable anchor devices for the target device, such as those estimated most reliable, according to the positioning QoS requirements of the target device.

FIG. 11 shows a collection of optional further features combinable with the in the coordination entity for mobile sidelink positioning of an example embodiment, including one or more of:
1101: obtaining by the first terminal device assistance data derived from the anchor feared event responses of one or more second terminal devices acting as anchor device candidates;
1102: deriving assistance data for the target device based on the received anchor feared event responses;
1103: estimating by the assistance data a probability of sidelink positioning failures of the anchor device candidates based on the received anchor feared event responses;
1104: providing the target device with the derived assistance data for positioning integrity determination of the target device;
1105: providing the target device with the assistance data concerning at least some or all the candidate anchor devices;
1106: selecting one or more first terminal devices for sidelink positioning of the target device based on the assistance data or the anchor feared event response;
1107: providing the target device with information about one or more first terminal devices as anchor device candidate;
1108: receiving a positioning assistance request for the target device;
1109: responsively to the positioning assistance request, initiating a selection of one or more first terminal devices for sidelink positioning of the target device;
1110: obtaining an anchor integrity value for the first positioning session based on a duration of an anchor device candidate availability;
1111: the mobility level is based on a beam misalignment of a sidelink positioning reference signal;
1112: establishing the first positioning session between the target device and a selected first terminal device;
1113: the coordination entity comprises a location management function, a base station, such as gNB, or a terminal device such as the first terminal device or the target device;
1114: sharing the candidate sidelink communication resource pool with the sidelink communication resource pool when no network support is available;
1115: establishing parallel sidelink positioning sessions when the target device is assisted by two or more first terminal devices;
1116: initiating the establishing of the sidelink positioning session by the coordination entity;
1117: initiating the establishing of the sidelink positioning session by the target device;
1118: the anchor feared event response further comprises one or more of further feared event indicators selected from a group consisting of: a traffic type of the candidate anchor device; a load of the candidate anchor device; a sidelink load of the candidate anchor device; a likelihood of a listen-before-talk failure of the candidate anchor device.

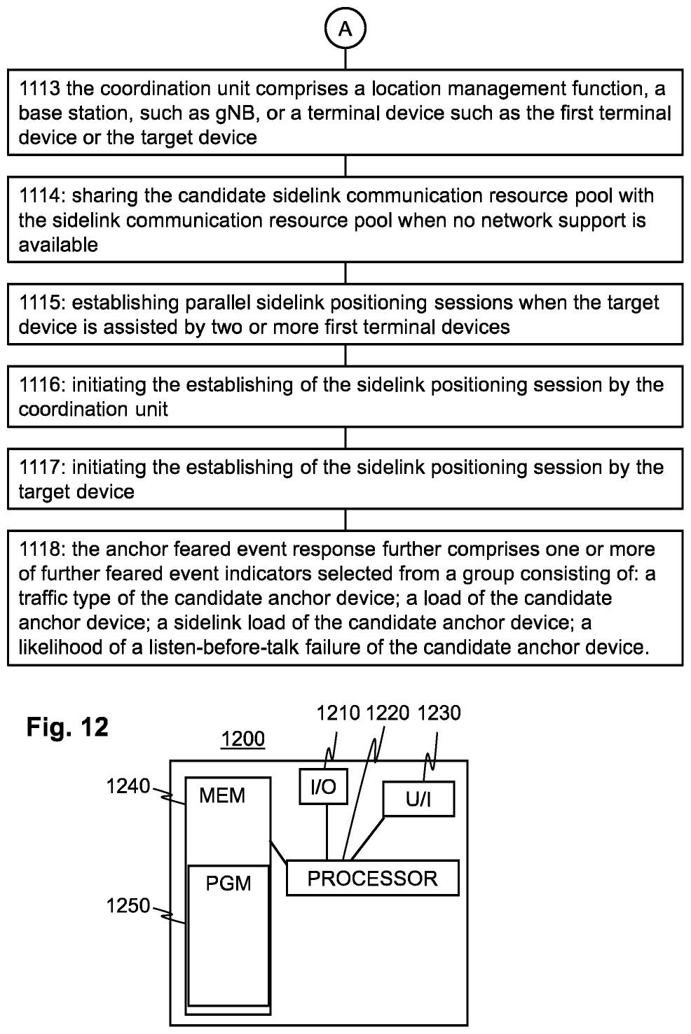

FIG. 12 shows a block diagram of an apparatus 1000 according to an embodiment of the invention.

The apparatus 1200 may comprise a memory 1240 including a computer program code 1250. The apparatus 1200 may further comprise a processor 1220 for controlling the operation of the apparatus 1200 using the computer program code 1240, a communication interface 1210 for communicating with other nodes. The communication interface 1210 comprises, for example, a local area network (LAN) port; a wireless local area network (WLAN) entity; Bluetooth entity; cellular data communication interface; or satellite data communication entity. The processor 1220 comprises, for example, any one or more of: a master control unit (MCU); a microprocessor; a digital signal processor (DSP); an application specific integrated circuit (ASIC); a field programmable gate array; and a microcontroller.

As used in this application, the term “circuitry” may refer to one or more or all of the following:
(a) hardware-only circuit implementations (such as implementations in only analog and/or digital circuitry) and;
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a terminal device or a similar integrated circuit in server, a cellular network device, or other computing or network device.

Without in any way limiting the scope, interpretation, or application of the claims appearing below, a technical effect of one or more of the example embodiments disclosed herein is that positioning integrity can be improved in mobile target device positioning that is based on position data of other terminal devices. Another technical effect of one or more of the example embodiments disclosed herein is that positioning integrity of the mobile target device may be verified and/or improved in sidelink positioning of the mobile target device. Yet another technical effect of one or more of the example embodiments disclosed herein is sidelink positioning of the mobile target device can be performed efficiently with either central or distributed control.

In an example embodiment, the application logic, software, or an instruction set is maintained on any one of various conventional computer-readable media. In the context of this disclosure, a “computer-readable medium” may be any non-transitory media or means that can contain, store, communicate, propagate, or transport the instructions for use by or in connection with an instruction execution system, apparatus, or device, such as a computer, with one example of a computer described and depicted in FIG. 12. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1-22. (canceled)

23. An apparatus comprising:
at least one processor; and
at least one memory storing computer program codes;
that when executed by the at least one processor, cause the apparatus at least to:
receive from a coordination entity an anchor feared event request for positioning of
a target device; and
transmit to the coordination entity an anchor feared event response that indicates at least one factor affecting a positioning integrity of the target device with the apparatus acting as an anchor device for sidelink positioning;
wherein the anchor feared event response comprises at least one of following feared event indicators:
a link quality characteristic of a channel between the apparatus and the target device; or power headroom of the apparatus.

24. The apparatus of claim 23, wherein the at least one memory storing computer program codes that, when executed by the at least one processor, further cause the apparatus to:
obtain assistance data derived from anchor feared event responses of one or more terminal devices acting as anchor device candidates.

25. A coordination entity comprising:
at least one processor; and
at least one memory storing computer program codes;
that when executed by the at least one processor, cause the coordination entity at least to:
transmit to one or more first terminal device an anchor feared event request for positioning of a target device; and
receive from at least a subset of the one or more first terminal device an anchor feared event response, wherein the anchor feared event response indicates at least one factor affecting a positioning integrity of the target device with the first terminal device acting as an anchor device for sidelink positioning;
wherein the anchor feared event response comprises at least one of following feared event indicators:
a link quality characteristic of a channel between the first terminal device and the target device; or
power headroom of the first terminal device.

26. The coordination entity of claim 25, wherein the at least one memory storing computer program codes that, when executed by the at least one processor, further cause the coordination entity to derive assistance data for the target device based on the received anchor feared event responses.

27. The coordination entity of claim 25, wherein the at least one memory storing computer program codes that, when executed by the at least one processor, further cause the coordination entity to provide the target device with the derived assistance data for positioning integrity determination of the target device.

28. The coordination entity of claim 25, wherein the at least one memory storing computer program codes that, when executed by the at least one processor, further cause the coordination entity to select one or more first terminal devices for positioning of the target device based on the assistance data or the anchor feared event response.

29. The coordination entity of claim 25, wherein the anchor feared event comprises an integrity result of a positioning estimate of the first terminal device.

30. The coordination entity of claim 25, wherein the anchor feared event response further comprises one or more of further feared event indicators selected from a group comprising:
user equipment type; interference in candidate sidelink resources as determined in result of sidelink sensing operations; power or battery status; mobility level; radio resource control mode, a traffic type of the candidate anchor device; a load of the candidate anchor device; a sidelink load of the candidate anchor device; and a likelihood of a listen-before-talk failure of the candidate anchor device.

31. The coordination entity of claim 30, wherein the mobility level is based on a beam misalignment of a sidelink positioning reference signal.

32. The coordination entity of claim 25, wherein the at least one memory storing computer program codes that, when executed by the at least one processor, further cause the coordination entity to receive a positioning assistance request for the target device.

33. The coordination entity of claim 25, wherein the at least one memory storing computer program codes that, when executed by the at least one processor, further cause the coordination entity to obtain an anchor integrity value for the target device based on a duration of availability of the first terminal device.

34. The coordination entity of claim 25, wherein the at least one memory storing computer program codes that, when executed by the at least one processor, further cause the coordination entity to establish a first positioning session between the target device and a selected anchor device candidate.

35. The coordination entity of claim 25 comprises at least one of the following:
a location management function,
a base station, or
a terminal device.

36. A method for a coordination entity comprising:
transmitting to one or more first terminal devices an anchor feared event request for positioning of a target device; and
receiving from at least a subset of the one or more first terminal devices an anchor feared event response, wherein the anchor feared event response indicates at least one factor affecting a positioning integrity of the target device with the first terminal device acting as an anchor device for sidelink positioning;
wherein the anchor feared event response comprises at least one of following feared event indicators:
a link quality characteristic of a channel between the first terminal device and the target device; or
power headroom of the first terminal device.

37. The method of claim 36, further comprising:
deriving assistance data for the target device based on the received anchor feared event responses.

38. The method of claim 36, further comprising:
providing the target device with the derived assistance data for positioning integrity determination of the target device.

39. The method of claim 36, further comprising:
selecting one or more first terminal devices for positioning of the target device based on the assistance data or the anchor feared event response.

40. The method of claim 36, wherein the anchor feared event comprises an integrity result of a positioning estimate of the first terminal device.

41. The method of claim 36, wherein the anchor feared event response further comprises one or more of further feared event indicators selected from a group comprising:
user equipment type; interference in candidate sidelink resources as determined in result of sidelink sensing operations; power or battery status; mobility level; radio resource control mode, a traffic type of the candidate anchor device; a load of the candidate anchor device; a sidelink load of the candidate anchor device; and a likelihood of a listen-before-talk failure of the candidate anchor device.

42. The method of claim 41, wherein the mobility level is based on a beam misalignment of a sidelink positioning reference signal.
